(19) United States
(12) Patent Application Publication
(10) Pub. No.: US 2025/0154054 A1
(43) Pub. Date: May 15, 2025

(54) Cartridge System for Injection of Resin for a Glass Defect Repair

(71) Applicants: Shiloh Spoo, Bend, OR (US); Thang Duong Ngo, Bend, OR (US)

(72) Inventors: Shiloh Spoo, Bend, OR (US); Thang Duong Ngo, Bend, OR (US)

(21) Appl. No.: 18/945,462

(22) Filed: Nov. 12, 2024

Related U.S. Application Data
(60) Provisional application No. 63/547,956, filed on Nov. 9, 2023.

(51) Int. Cl. C03C 27/10

(52) U.S. Cl. CPC C03C 27/10

(57) ABSTRACT

A cartridge for injecting curable repair resin into a glass defect formed in glass, such as a windshield is provided. The cartridge has a body which is configured for operative coupling with a resin injector which, when actuated, injects resin into the glass defect. Actuation of the coupled resin injector acts to reduce the size of an interior chamber in the cartridge to thereby force a resin supply therein to a communication with the glass defect.

This application claims priority to U.S. Provisional Patent Application Ser. No. 63/547,956 filed on Nov. 9, 2023. The present invention relates generally to the repair of defects, such as cracks, formed in glass and laminated glass products, such as windshields. More particularly, the invention relates to a cartridge system for the positioning and the injection of repair resin into cracks and defects in the glass using an injector.

### BACKGROUND OF THE INVENTION

### 1. Field of the Invention

### 2. Prior Art

Glass is a widely employed product throughout the world to provide a barrier to the exterior of a vehicle or building. Such glass panels provide a viewable area on one side of the glass panel which can be viewed by a person on an opposite side of the glass sheet. Such glass panels are employed in the windows and doors of buildings and also in a laminated configuration in vehicles.

Where protection from impacts and high winds and the like is a necessity, laminated glass panels are widely employed. Such glass consists, generally, of one or a plurality of layers of glass material having one or a plurality of layers of a tough polymeric material or resin operatively engaged thereto. In such laminated glass, when it is impacted by a flying object or the like, while the glass panel will not fail, defects and cracks are formed into the glass sheet. To that end, where such laminated glass sheeting is employed, the glass portions, when damaged, are held in place by the resin interlayer between or upon the plurality of layers of glass. Thus, the polymeric layer will act to maintain the layers of glass bonded together even when broken by such an impact, thereby preventing the glass panel from breaking up into sharp pieces.

Such laminated glass is conventionally employed when there is a possibility of impact by flying objects with humans or where the glass panel pieces could fall, if shattered. For example, skylight glazing and automobile windshields typically use laminated glass. In geographical areas requiring hurricane-resistant construction, laminated glass is often employed in windows located on exterior facing walls.

Laminated type glass sheeting is also widely used by vehicle manufacturers for vehicle windows. Both the side windows and the front and rear windshields are conventionally formed in this type of construction and are probably one of the most common conventional forms of laminated glass.

It should be noted that where referred to herein, laminated glass may be referred to as a windshield or pane or a sheet. For ease of description and convenience, such a reference will also apply to any type of glass having such a laminated construction where polymeric sheets or layers are bonded to glass panels.

As previously mentioned, laminated glass, such as a windshield for a vehicle, is commonly constructed of two glass layers and an intermediate layer of tough plastic. A similar configuration is employed in building windows. However, such may also have exterior polymer sheeting.

When a conventional vehicle windshield, formed of such laminated glass, suffers an impact from an object, a localized break in the glass structure is frequently formed. Such breaks frequently take the form of a bull's-eye or a star and can initially have small cracks radiating from a point, opening on the surface outwardly and downwardly through the outer lamination of the resin interface. Where laminated glass is impacted to form a small bull's-eye or a star without further cracking across the entire pane or windshield, there exists an ongoing future risk of a large crack developing which will move outward from the initial impact point is present.

When such damage occurs to a vehicle windshield or similar laminated glass panel, various contaminants including air and moisture may become trapped between the two layers of glass and within the formed crack or defect. These voids or defects will weaken the windshield thereby compromising the structural integrity of the windshield and its ability to properly support the structure of the vehicle.

Differing methods and devices have been developed over many years which enable such small impact craters and cracks to be repaired. Such repairs produce, generally, a substantially clear or transparent viewing through the resin cured into the impacted area of the glass and also provide an adherence of the cured resin to the glass material which helps prevent long cracks from developing across the pane or windshield.

Conventionally, the injection of the resin is accomplished using a resin injector. The resin injector is loaded with a quantity of UV curable resin from a bottle or other resin holder. The quantity loaded is sufficient to repair the crack and, thereafter, forces the resin into the defect into the glass whereafter UV light is employed to cure the resin.

The forgoing examples of related art, as to reflected light from the areas of cured resin positioned into cracks and impact areas of laminated glass, and the limitations related therewith, are intended to be illustrative and not exclusive, and they do not imply any limitations on the invention described and claimed herein. Various other limitations in the related art of laminated glass repair will become apparent to those skilled in the art upon a reading and understanding of the specification below and the accompanying drawings.

### SUMMARY OF THE INVENTION

The cartridge system herein for the positioning of resin for use by a resin injection tool employed to force resin into glass defects is a significant advance in the loading of UV curable resin into injectors. The system, through the provision of cartridges having a pre-loaded amount of resin of a type that is proper for the defect to be fixed, eliminates the need to measure minute amounts of resin and thereafter position the chosen and measured resin into an injector therefor.

In the repair of cracks and other defects in a modern polymer laminated glass sheet, such as a windshield, the repair technician, employing a resin injector to repair such a crack or glass defect, will first choose a particular resin type from a number available based on the type of glass being repaired, and/or the type and size of the defect therein, and/or the temperature. The user will load a measured quantity of the chosen resin into a reservoir chamber of an injector in an amount required for both the repair and the operation of the resin injector. This measured amount of resin will be taken from a larger container of resin. Depending on the technician, this can be wasteful, and from an inventory control standpoint, it makes tracking the amount of resin used and the amount left in the container hard to discern.

In the system herein, UV curable repair resin is pre-loaded into a sealed cavity of a cartridge. The cartridge is configured for placement within the resin injector employed for forcing the resin into the crack or defect in the glass. There are a number of manufacturers of such injectors and the cartridge herein may be easily designed in size and exterior configurations to operatively couple with the respective different available resin injectors. Such resin injectors are available from a number of manufacturers such as and in no way limiting Glasweld Corporation of Bend, Oregon, or Liquid Resins International of Olney, Illinois and other firms. By the term operatively couple or operatively coupled herein is meant, that the exterior dimensions of the cartridge are configured to couple with a resin injector used for glass repair, whereafter conventional operation of the resin injector will reduce the volume of an interior chamber and force resin from the carriage for communication to a glass defect. Preferably once coupled, the injector will operate in the conventional fashion in order to allow for use of the cartridge system without the need to retrain thousands of technicians who are already using the injector with measured amounts of resin.

Each cartridge will, as noted, be pre-loaded with a supply of UV curable resin within a sealed internal cavity of the cartridge. This sealed cavity insures that the resin is not exposed to surrounding air and humidity. The walls the cartridge surrounding the interior cavity may be formed of polymeric or other materials which will block light transmission into the resin within the internal cavity to eliminate or minimize light exposure to the resin.

The cartridges may be color coded or labeled with indicia as to the type and/or amount of repair resin within the cartridge. In this fashion multiple types of resins, which are formulated for specific different repairs, can be carried by the technician. This allows the technician to easily choose the correct cartridge having the correct resin supply within the interior cavity which matches the type of resin needed for the specific repair. This will not only aid technicians in matching the correct resin required for a particular glass repair, it will also allow them to carry many types of repair resin without the need to carry large reservoir bottles of such which an get lost or contaminated.

Further, the cartridges may bear scannable indicia, such as a bar code or other scannable indicia thereon. The positioning of scannable indicia on the exterior of the cartridge or packaging therefor, if in a package, allows for a more efficient method of glass repair using the cartridges herein. When a cartridge is used, it may be first scanned and the scannable indicia will allow for a computer cross check of the resin within the cartridge to that required for the repair. The scannable indicia also allows for a computer recording of what date, at what location, and upon which window a cartridge was used for a repair and the identity of the technician using it. Software operating to the task of receiving the scanned image of the indicia can handle the tasks noted, such as cross checking and recording the use. This ability to employ a scanner, such as a smart phone or a dedicated computing device, will be most helpful in maintaining an inventory of the required cartridges for each technician and tracking use of the cartridges over time for inventory and security purposes.

Each cartridge has an exterior surface configuration which configures it to be operatively coupled into or upon a resin injection device and to allow the injection device to use the resin within the carriage to repair glass in a substantially conventional fashion. The carriages themselves may be dimensioned for operative coupling to the injectors of each manufacturer, or, a connector or adapter that allows them to be so coupled.

At the leading end of the cartridge will be an injector tip for pressurized injection of resin from the internal cavity into a window crack. In some modes of the device, one or a plurality of air channels which allow the user to pull a vacuum from a crack or defect may be positioned within an annular seal located on the end of the cartridge or upon the injector, which the technician places to surround the defect. Air passages are particularly where the cartridge is loaded into an injector at the start of the repair procedure in order to allow easy use by technicians already trained in the steps of repair.

With the vacuum pulled and the cartridge loaded, the user will reverse movement of a plunger of the injector tool which is coupled with a second end of the cartridge. Translation of a plunger will cause force to be imparted against the second end of the cartridge opposite a first end thereof. As the force from a plunger continues, the exterior housing of the cartridge will collapse. This collapse will cause the liquid resin, held in the interior resin cavity, to break a seal on the first end thereof whereupon the resin to flow into the glass defect under both pressure from the collapsing housing and the pulling draw of the vacuum.

Thereafter, conventionally, the technician must then illuminate a UV light source for a determined duration of cure time for the injected resin. Once cured, the crack or other defect in the glass will rarely enlarge since the resin fills the defect and adheres to it to hold the window together in the area of the defect.

The resin cartridge system herein, once configured for operative coupling with a resign injector thus allows for widespread use in a variety of different and widely employed resin injection systems for glass, while allowing conventional use and steps in the repair. This allows technicians to employ the cartridges in a conventional repair fashion with little or no new training thereby encouraging widespread use.

Additionally, during the injection step, wherein the resin is communicated into the crack or defect in the glass, it has been found that concurrently communicating vibration to the glass in the area of the crack being repaired can significantly improve both the amount of resin flowing into the defect and the area into which the resin flows. Vibration communicated to the glass while the resin is flowing into the defect, helps to disburse the resin into smaller and tighter areas of the defect. Once cured, such will significantly increase the hold of the cured resin to a larger area within the defect.

Currently, there are three modes of communicating such vibration to the glass being repaired. In one mode, a vibrating unit is engaged to the housing of the injector. In a second mode of imparting vibration during the process, a vibrating component may be engaged to one of the leg supports holding the housing against the glass. In this mode the vibration is communicated to the housing and thereafter to the glass from the vibration component on the leg which is in contact against the housing. Finally, for the existing injectors not having a vibration component, an engageable member, having a vibrating unit thereon, can be employed. A contact on one end of an elongated member, having the vibrating component thereon, would engage with a point on the injector housing. Vibration would be communicated from the elongated member to the housing and thereafter to the glass.

With respect to the above description, before explaining at least one preferred embodiment of the herein disclosed cartridge system for window repair resin in more detail, it is to be understood that it is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other collapsing resin cartridges and cartridge systems which are employable with conventional injectors for use in the repair of glass, such as windshields. It is important, therefore, that the claims be regarded as including such equivalent construction and methodology insofar as they do not depart from the spirit and scope of the present invention.

It is an object of this invention, to provide collapsible cartridges which are configured for operative coupling to a resin injector to inject resin into glass defects during repairs.

It is an additional object of this invention to provide indica upon the exterior of the cartridges or packaging thereof if used, which is employable to identify the type of resin within the cartridge.

It is an additional object of this invention to provide a cartridge-base system for transport and use of resins in the repair of glass.

It is a further object of this invention to provide a cartridge resin system which allows for scannable tracking of the use of each cartridge to better control inventory and use.

It is a further object of this invention to provide a resin injector for repair of defects in glass which communicates a vibration to the glass concurrently with the injection of the resin.

The objects, features, and advantages of the present resin cartridge invention, as well as the advantages thereof over existing prior art, which will become apparent from the description to follow, are accomplished by the improvements described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the glass repair cartridge system for repair resin. It is intended that the embodiments and figures herein are to be considered illustrative of the resin cartridge system and method herein, rather than limiting.

In the drawings:

FIG. 1 depicts a conventional resin injector, employable with the resin cartridges herein, shown in an as-used positioning for injecting a curable resin in liquid form into a crack or defect area in glass, such as a vehicle windshield.

FIG. 2 depicts a sectional view through a conventional injector, such as in FIG. 1, showing a plunger of a conventional resin injector which communicates force to collapse the exterior housing of the resin-filled cartridge of the system herein.

FIG. 2A depicts a side view of a cartridge having an interior chamber surrounded by a collapsible exterior housing defining the shape and dimensions of the cartridge, and showing an optional seal which may be provided on or with the cartridge.

FIG. 3 shows the cartridge holding the supply of curable resin for glass repair herein in a collapsed configuration wherein the housing has been collapsed by the operatively coupled injector causing the resin within an interior cavity to be forced into the glass defect.

FIG. 4 depicts an enlarged view of another mode of the cartridge for window resin herein, showing passages for communication of air during a vacuum pull and projections to hold it mounted where needed, and showing scannable indicia such as a bar code.

FIG. 5 shows the cartridge of FIG. 4 in the collapsed configuration as in FIG. 2.

FIG. 6 depicts a view of the first end of the cartridge which has a central passage for communication of resin to the glass defect, and may also have air passages for drawing a vacuum and projections to hold the cartridge in a fixed position in the injector.

FIG. 6A depicts another mode of the cartridge herein showing telescopically engaged portions of a sidewall of exterior housing which will collapse under force from the operatively coupled injector and cause the interior chamber to collapse and force resin to eject therefrom.

FIG. 6B depicts a mode of the carriage herein wherein an endwall positioned inside the housing will force resin from the interior cavity as force from the operatively coupled injector is communicated to the endwall.

FIG. 7 shows a configuration of a resin injector having a vibrating component engaged thereon.

FIG. 8 depicts a vibration component for employment during resin injection wherein the vibration component is operatively engaged with the support stand for the injector housing.

FIG. 9 shows a vibrating component engaged with an elongated member having a connector on one end adapted to engage and communicate vibration from the vibrating component to the housing of the injector.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer depictions as they are oriented and appear in the drawings and are used for convenience only and they are not intended to be limiting or to imply that the resin-holding cartridge or components thereof have to be used or positioned in any particular orientation, or formed in any particular configuration providing for operative coupling to an injector.

Now referring to drawings in FIGS. 1-9, wherein similar components are identified by like reference numerals, there can be seen in FIG. 1 a prior art or conventional resin injector 12 which is employed to inject a liquid resin into a defect 14, such as a crack or star or the like, in glass 16, such as a vehicle windshield. Conventionally, such injectors form a seal on a dispensing end thereof with the glass 16 around the area of the defect 14. Professional grade injectors 12, as is well known, operate to first pull the air and moisture from the defect 14, and in a second step, communicate the resin into it using the force from the injector 12 and the vacuum formed within the defect 14 and to force the resin therein.

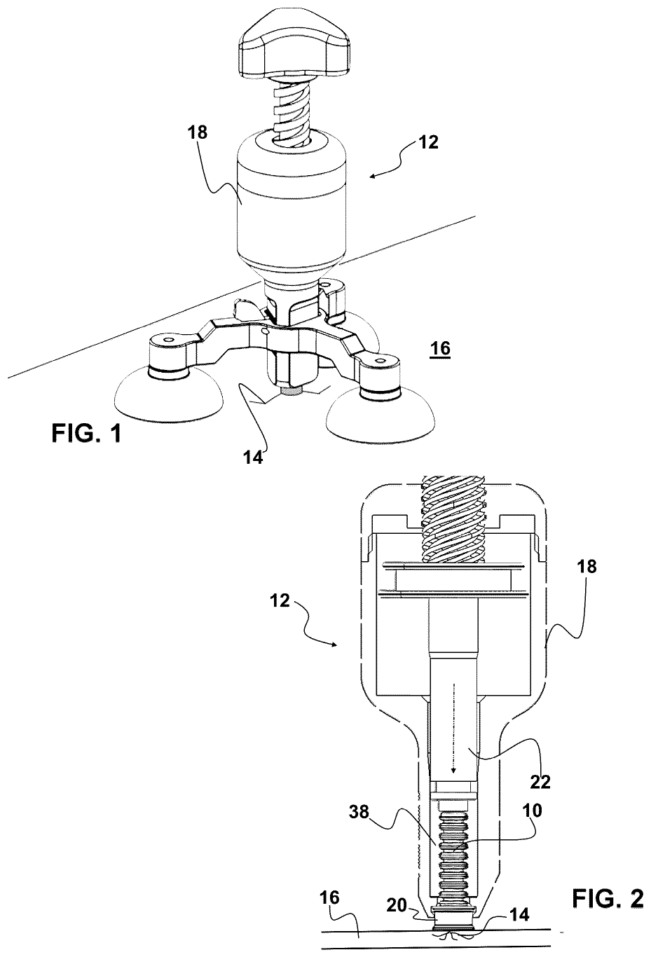

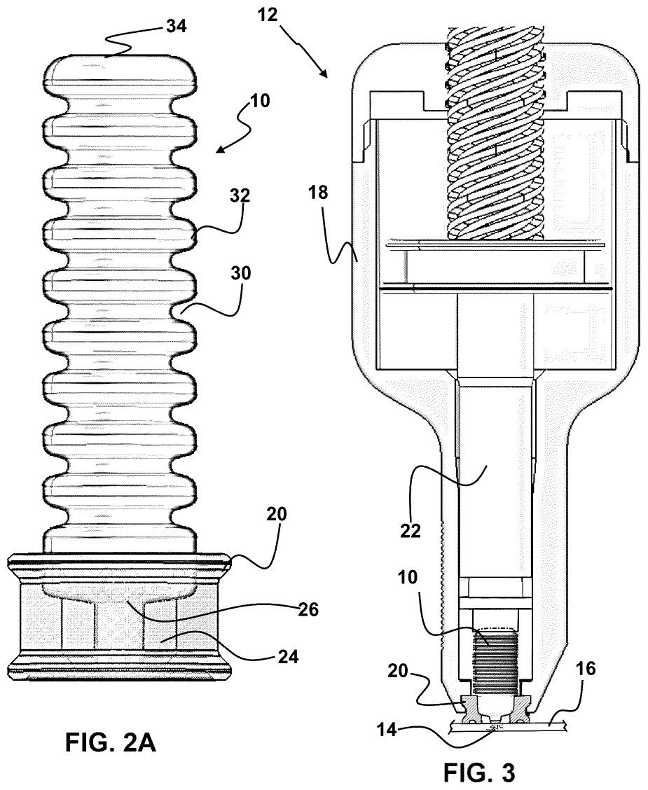

Shown in FIG. 2 is a sectional view through the housing 18 of a conventional injector 12 for which the configuration of the cartridge 10 herein is adapted to operatively couple. As shown operatively coupled with the depicted injector 12, the cartridge 10 herein is, in an engaged position at the engagement end of the housing 18 which is the end employed to inject resin into the defect 14 in the glass 16. Of course with other injectors 12, the shape and length and other dimensions may change to accommodate an operative coupling therewith.

As shown in the depicted operative coupling of FIG. 2, the cartridge 10 is located within a central passage of the housing 18 and has a first end located within a seal 20 which is positionable upon the glass 16. A passage communicates through the center of the seal 20 when in a sealed contact with the underlying defect 14, such as a crack.

During operation of the injector 12, a translation of a central member 22 or other compression component in a direction away from the injection end 26 and the defect 14 will cause a vacuum to form within the defect 14 and the opening 24 of the seal 20. When the injector 12 is operated to reverse the direction of travel of the central member 22, such reduces the volume of the interior chamber 11 and causes resin within the cartridge 10 to be forced from an injection end 26. The resin 15 is then drawn into the defect 14 by the vacuum previously pulled.

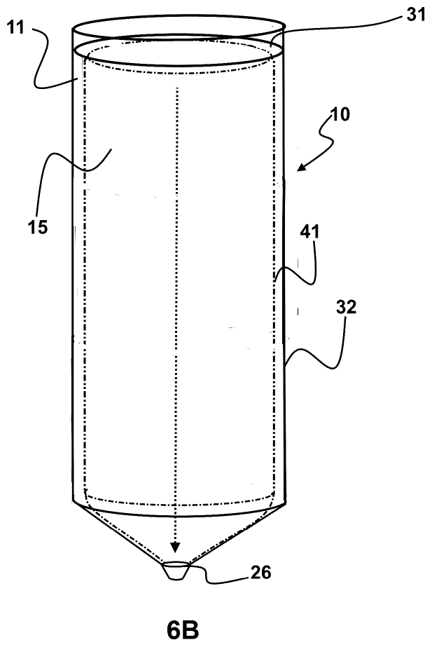

As noted, the cartridge 10 is configured on the exterior for operative coupling with the chosen injector 12 so the depiction herein should not be considered limiting as the cartridge 10 may be formed to other exterior configurations for operative coupling with the injector 12 of other manufacturers wherein actuation of the injector 12 will cause a reduction in the volume of the interior chamber 11 to inject the resin 15 into a defect 14. Other examples of such are shown in FIG. 6A, for example, with a telescopic sidewall 32 and 6B where a translating endwall 31 will translate into the interior chamber 11 toward the injection end 26.

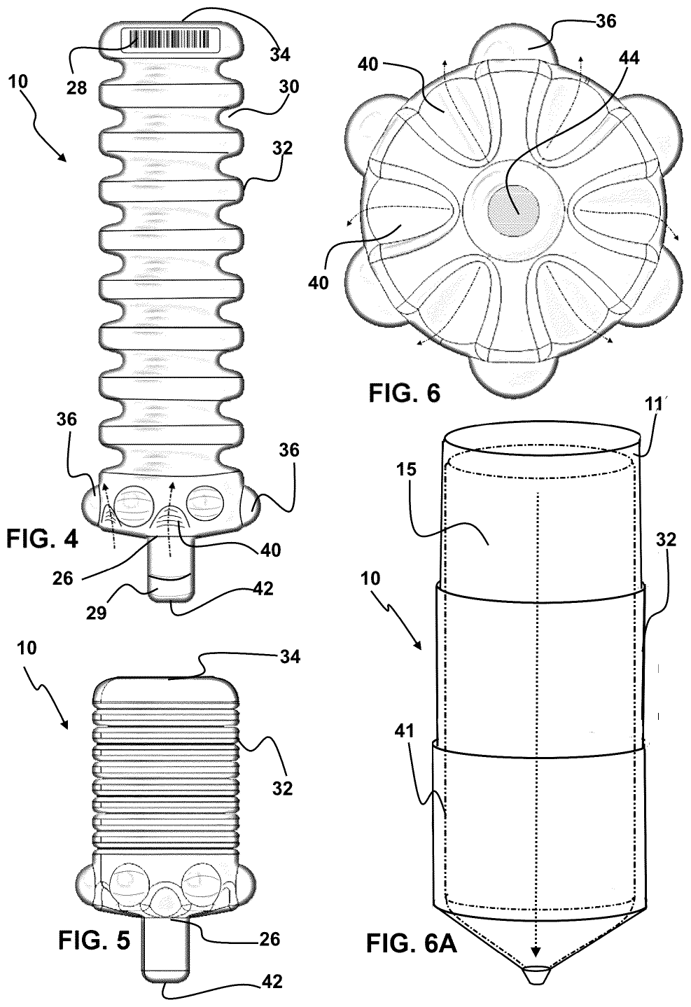

FIG. 2A depicts a side view of a cartridge 10 wherein a body thereof has an interior chamber 11 surrounded by a collapsible sidewall 32 defining the shape and dimensions of the cartridge 10. The sidewall 32 communicates between an injection end 26 or first end and a cartridge endwall at a second end 34 and surrounds the interior chamber 11 which can be seen in 6A, for example. Shown in FIG. 2A is also a seal 20 which can be included on the injection end 26 of a cartridge 10 or provided for mounting thereon for use. In the mode of the cartridge, shown in FIG. 2A and FIG. 4, the sidewall 32 of the cartridge is shaped like an accordion to allow for collapse thereof to cause a reduction in volume within the interior chamber 11 holding the resin 15. This reduction in volume of the interior chamber 11 causes the resin 15 to disperse from the injector end 26 whereupon it will be forced into the defect 14.

As shown in FIG. 3, a compression of the cartridge 10 by translation of the central member 22 or other operation of the injector 12 to reduce the volume of the interior chamber 11 will actuate the cartridge 10 to release the resin 15 therein.

As noted, actuation of an injector 12 to release the resin 15 may be provided by the compression itself, making the interior chamber 11 of the cartridge 10 smaller and forcing the liquid resin 15 therefrom. The interior chamber 11 may be made smaller by collapsing a sidewall 32 or reducing the volume of the interior chamber 11 by translating a translating endwall 31 (FIG. 6b) or other means for reducing the volume of the interior chamber 11 upon actuation of the injector 12 as would occur to those skilled in the art.

In some modes of the cartridge, a valve 29 may be positioned at the injection end 26 of the cartridge 10 which is configured to open during such compression or in combination with some compression communicated to the cartridge 10 to reduce the volume of the interior chamber 11 and the force of the drawn vacuum within the seal 20 and the defect 14.

Shown in FIG. 4 is an enlarged view of one mode of the cartridge 10 configured to hold a supply of window repair resin 15 within an interior chamber 11 therein. As shown, the cartridge 10 is in the enlarged configuration prior to use. The cartridge 10 can hold any resin 15 adapted to the task of window repair within the interior chamber, and different cartridges 10 could be configured with differing resins therein which are adapted for employment with differing types of defect 14 repairs. Similar to other cartridges herein, the sidewall 32 is collapsible by formation in an accordion shape.

The mode of the cartridge 10 of FIG. 4, as noted, allows for multiple identifiable cartridges 10 to be prepared with differing resins 15 adapted for the repair of differing defects 14 whereby the user could choose the cartridge 10 having the desired resin therein for the task at hand from a plurality of different cartridges 10 with differing resins therein. A means to identify which particular resin 15 is within a respective cartridge 10, an individual cartridge 10 itself, may be provided by indicia 28 on each cartridge 10 identifying the enclosed resin 15 or the individual cartridge 10 itself for inventory and other purposes. Additionally, the type of resin 15 within a cartridge 10 may be visually identified by forming the casing of the cartridge 10 in different colors, whereby the user would choose the cartridge 10 having the color which correlates to the resin within which correlates to the repair to be made.

In this enlarged mode of FIG. 4 can also be seen the plurality of recesses 30 formed into the sidewall 32 of the cartridge 10. The recesses 30 forming an accordion shape allow pressure on the second end 34 of the cartridge 10, such as by the central member 22, to collapse the sidewall 32 and concurrently collapse the interior chamber 11 therein. This structure allows operation of the cartridge 10 to move to the collapsed configuration of FIG. 5 which provides the force to collapse the interior cavity 11 and to eject the resin 15 from the injection end 26 of the cartridge 10. As noted above, the resin 15, so ejected, will flow into the defect 14 and that flow is aided by the vacuum previously drawn.

Also shown in FIGS. 4-6, at the injection end 26 of the cartridge 10, there may be positioned a plurality of projections 36 radially around the external circumference of the cartridge 10. These projections 36 provide a means to position and hold the cartridge 10 within the axial passage 38 (FIG. 2) of an injector 12 having such, in a stable and centered positioning. To provide conduits for drawing of the vacuum by the injection, noted above, currently, there are also a plurality of recesses 40 formed into the edge of the body of the cartridge 10 in positions surrounding the injector end 26.

At an endwall 42 at the injector end 26 is positioned an exit passage 44 (FIG. 6) for the flow of resin 15 from the interior chamber 11 into the defect 14 during use. Currently, this exit passage 44 may be covered by a removable tab, in one mode, to maintain the resin 11 within the internal cavity. In another mode, a valve may be positioned in the exit passage of the endwall 42 which is configured to be closed when no vacuum is present and to open under a combination of vacuum drawn and pressure caused by the collapse of the sidewall 32 and interior cavity 11, thereby forcing resin from the exit passage 44. Alternatively, to use the cartridge 10, the endwall 42 can simply be cut off to reveal the open exit passage 44.

FIG. 6A depicts another mode of the cartridge 10 herein showing telescopically engaged portions of the sidewall 32 of the cartridge 11 which will translate and collapse under force from an injector 12 thereby reducing the volume of the interior chamber 11 and causing the resin 15 to eject resin therefrom. Seals would be positioned as needed along the sidewall 32 and/or the resin 15 may be enclosed in an envelope 41 which will burst as the volume of the interior chamber 11 gets smaller.

FIG. 6B depicts a mode of the carriage herein wherein a translating endwall 31 is positioned inside the interior chamber 11 of the cartridge 10. Actuation of an injector 12 to which the cartridge 10 is operatively coupled will force the translating endwall 31 toward the injection end 26 reducing the volume of the interior chamber 11 to force resin 15 from the interior chamber 11 to be communicated to a defect 14.

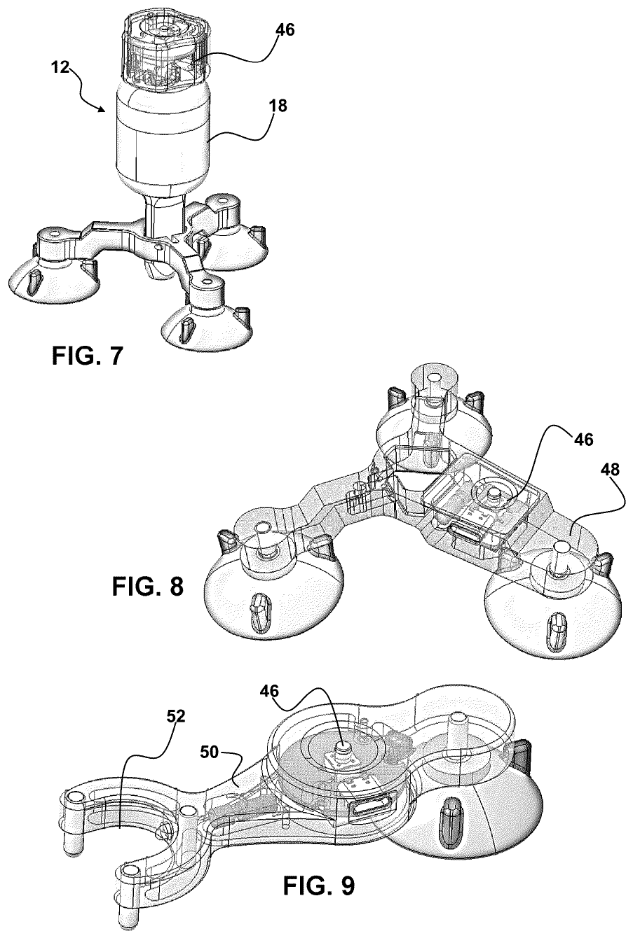

To enhance the communication of resin in the system herein as well as other injector systems, which may not employ cartridges 10, the communication of vibration to the glass 16 and defect 14 therein during injection can be provided. As shown in FIG. 7, a vibration component 46 operatively engaged to the housing 18 of the resin injector 12 can be provided. Such a vibrating component 46, for example and in no way limiting, would have an onboard electric power supply, such as a rechargeable or conventional battery which powers an eccentric vibrating motor all well known components.

In another manner to communicate such vibration during the injection of resin 15, the vibration component 46 may be operatively engaged with the support stand 48 which holds the housing 18 in position against the glass 16 during the injection procedure. In this mode the vibration from the vibrating component 46 is communicated to a support member of the support stand 48 and into the housing 18 operatively connected thereto.

In still another configuration, shown in FIG. 9, the vibration component can be operatively engaged to an elongated member 50 having a connector 52 thereon. The connector 52 will be configured to engage and communicate vibration from the vibrating component 46 through the elongated member 50 and to the housing 18 of a resin injector 12.

While all of the fundamental characteristics and features of the curable resin cartridge system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A cartridge for injecting curable resin into a glass defect, comprising:
a cartridge having a body having a first end opposite a second end and having a sidewall communicating between said first end and said second end;
an interior chamber for holding resin, said interior chamber located between said first end and said second end, said interior chamber surrounded by said sidewall;
said body configured for operative coupling with a resin injector;
a volume of said interior chamber being reduced upon an actuation of said resin injector whereby said resin is expelled therefrom for injection into a glass defect formed in glass.

2. The cartridge for injecting curable resin into window defects of claim 1, additionally comprising:
said sidewall having a plurality of recesses formed therein imparting an accordion shape to said sidewall; and
said sidewall moving from an extended configuration to a collapsed configuration upon said actuation of said resin injector there by reducing said volume of said interior chamber.

3. The cartridge for injecting curable resin into window defects of claim 1, additionally comprising:
said sidewall formed of a plurality of telescopically engaged sections; and
said sidewall moving from an extended configuration to a collapsed configuration upon said actuation of said resin injector thereby reducing said volume of said interior chamber.

4. The cartridge for injecting curable resin into window defects of claim 1, additionally comprising:
a translating endwall positioned within said interior chamber adjacent said second end of said cartridge; and
said actuation of said resin injector imparting a translation of said translating endwall toward said first end of said cartridge thereby reducing said volume of said interior chamber.

5. The cartridge for injecting curable resin into window defects of claim 1, additionally comprising:
scannable indicia positioned upon an exterior surface of said cartridge; and
said scannable indicia for scanning an indicia image by a computing device; and
said indicia image communicable to a computing device having software running thereon operating to the task of identifying a type of said resin positioned within said interior chamber to a user of said resin injector to which said cartridge is operatively coupled.

6. The cartridge for injecting curable resin into window defects of claim 2, additionally comprising:
scannable indicia positioned upon an exterior surface of said cartridge; and
said scannable indicia for scanning of an indicia image thereof by a computing device;
said indicia image communicable to a computing device having software running thereon operating to the task of identifying a type of said resin positioned within said interior chamber to a user of said resin injector to which said cartridge is operatively coupled.

7. The cartridge for injecting curable resin into window defects of claim 3, additionally comprising:
scannable indicia positioned upon an exterior surface of said cartridge; and
said scannable indicia for scanning of an indicia image thereof by a computing device; and
said indicia image communicable to a computing device having software running thereon operating to the task of identifying a type of said resin positioned within said interior chamber to a user of said resin injector to which said cartridge is operatively coupled.

8. The cartridge for injecting curable resin into window defects of claim 4, additionally comprising:
scannable indicia positioned upon an exterior surface of said cartridge; and
said scannable indicia for scanning of an indicia image thereof by a computing device; and
said indicia image communicable to a computing device having software running thereon operating to the task of identifying a type of said resin positioned within said interior chamber to a user of said resin injector to which said cartridge is operatively coupled.

9. The cartridge for injecting curable resin into window defects of claim 1, additionally comprising:
a seal engageable on said first end of said body, said seal having an opening centrally positioned therein; and
said seal for forming a seal upon glass to be repaired with said opening encircling said defect and a first end of said seal in a sealed connection with glass surrounding said defect.

10. The cartridge for injecting curable resin into window defects of claim 2, additionally comprising:
a seal engageable on said first end of said body, said seal having an opening centrally positioned therein; and
said seal for forming a seal upon glass to be repaired with said opening encircling said defect and a first end of said seal in a sealed connection with glass surrounding said defect.

11. The cartridge for injecting curable resin into window defects of claim 1, additionally comprising:
a vibrating component;
said vibrating component engageable with said resin injector to an engaged position; and
said vibrating component for communicating vibration therefrom to said defect.

12. The cartridge for injecting curable resin into window defects of claim 2, additionally comprising:
a vibrating component;
said vibrating component engageable with said resin injector to an engaged position; and
said vibrating component for communicating vibration therefrom to said defect.

13. The cartridge for injecting curable resin into window defects of claim 5, additionally comprising:
a vibrating component;
said vibrating component engageable with said resin injector to an engaged position; and
said vibrating component for communicating vibration therefrom to said defect.

14. The cartridge for injecting curable resin into window defects of claim 9, additionally comprising:
a vibrating component;
said vibrating component engageable with said resin injector to an engaged position; and
said vibrating component for communicating vibration therefrom to said defect.

15. The cartridge for injecting curable resin into window defects of claim 1, additionally comprising:
an arm having a first end removably engageable with said glass;
said arm having a second end removably engageable with a first end of a resin injector; and
a vibrating component engaged with said arm for communicating vibration therefrom to said glass.
